(19) United States
(12) Patent Application Publication
(10) Pub. No.: US 2016/0125373 A1
(43) Pub. Date: May 5, 2016

(54) SYSTEM AND METHOD FOR CONCURRENT ELECTRONIC REMITTANCE AND FUNDS TRANSFER

(71) Applicants: Robert Chevlin, Delray Beach, FL (US); Travis Dulaney, Plantation, FL (US)

(72) Inventors: Robert Chevlin, Delray Beach, FL (US); Travis Dulaney, Plantation, FL (US)

(21) Appl. No.: 14/530,196

(22) Filed: Oct. 31, 2014

(51) Int. Cl. G06Q 20/10; G06Q 20/34; G06Q 50/22; G06Q 20/14

(52) U.S. Cl. CPC G06Q 20/108; G06Q 20/14; G06Q 20/34; G06Q 50/22

(57) ABSTRACT

A system and method for concurrent electronic remittance and funds transfer that allows for the simultaneous electronic transfer of funds to a service provider for payment of a liability and transmission of a standardized electronic remittance transmittal which includes details concerning the payment. When implemented in medical billing environments, the system and method is operative to transmit an electronic notice of payment for a specified amount to a service provider payee upon receipt of an electronic claim payment file from a health insurer payer. Once electronic payment is accepted by the payee, an Original Credit Transaction that immediately credits the payment into an existing bank account of the payee. At the same time, an 835 Electronic Remittance Advice which includes details about the payment is electronically transmitted to the payee, enabling the payment transaction to be automatically documented in the payee's practice management system that receives the 835.

### BACKGROUND OF THE INVENTION

1. Field of the Invention

This invention relates generally to electronic payment information transmission and funds transfer systems and methods and, more particularly, to a system and method for availing electronic payment data files formatted for direct use in an Electronic Data Interchange environment to a recipient while simultaneously transferring funds relevant to the availed electronic payment data files directly into a bank account of the recipient.

2. Description of the Prior Art

The use and operation of Electronic Data Interchange (“EDI”) electronic communication systems for exchanging business documents embodied as data files in a standardized format is well established. In available in various business fields, EDI systems facilitate an automated exchange of information, generally enabling the transmission of business document information directly into an appropriate application on a recipient's computer and eliminating the need for document information to be manually processed by the recipient. Such an automated exchange of business document information is well known to provide reductions in cost, increases in processing speed, and a reduced in errors relative to systems which rely on the exchange of documents in paper form (i.e. mail, fax) or electronically (i.e. email) and the subsequent handling of the same by people.

In the medical field, an electronic remittance advice (“ERA”) defines an electronic payment explanation document which provides to a service provider details about payments of their claims and explanations for denied claims. The HIPAA X12 835 (“835”) is the standardized electronic remittance for providing ERA data within the context of the EDI environment. As used herein, “835” and “835 Electronic Remittance Advice” shall be used to reference the prevailing industry standard for sending payment explanation or ERA data, which may be the HIPAA X12 835 at the time of writing but may change in the future.

As an ERA, an 835 is typically provided to the service provider (or “payee”) in response to a health care claim submission to detail the payment to that claim. As such, an 835 is operative to input claim payment related information, such as information about the payee, payer, payment, and insurance handling, directly into a practice management system of the payee.

Upon the creation and/or transmission of an 835, the party responsible for paying amounts owed to the payee (referred to herein as the “payer”) typically additionally must make arrangements to get money in the amount of the payment to be made to the payee. Conventional payment methods employed to transfer the money from the payer to the payee include ACH, the mailing of paper checks, and the distribution and funding of stored value payment cards. Generally, ACH is only an available option if the payer has an existing financial relationship with the payee otherwise paper check or stored value cards are the only other existing options. With paper checks, a payer (and/or third party processing firm) will generally issue and avail an 835 to a payer, place funds to a transaction account, and then print and mail a check drawn on the transaction account to the payer. Under such circumstances, the payee typically must deposit the check into their bank account and manually associate in their books the 835 and the deposit. As such, the use of checks to transfer funds generally requires a significant amount of manual processing despite the use of the 835.

An example of a stored value cards based system is provided by U.S. Pat. No. 8,249,893, which discloses a method of facilitating payments to medical practitioners (as service providers) through the processing of a virtual payment card embodied, as stored value cards, by the service provider responsive to a payment.

Similarly, U.S. Pat. No. 7,792,686 discloses a method of facilitating payment of health care benefits on behalf of a payer comprising the step of electronically transmitting a stored-value card account payment of the authorized benefit amount concurrently with an explanation of benefits.

With respect to such stored value card based systems, however, the payer (and/or one or more third party processing firms) must often manually preload funds on to the stored value card prior to it being run by the payee and then, upon a transaction with the card being approved, transmit explanation of benefits file (or electronic remittance advice, such as an 835) through separate system. Furthermore, the payee will often be required to manually run payment the stored value card on a payment card terminal to process a transaction for the funds and then manually associate in their books the explanation of benefits file and the processed transaction and subsequent deposit. Thus, the use of stored value cards often will still require a substantial amount of manual processing despite the use of the 835. Moreover, the amount deposited into the payee account is typically discounted by the merchant interchange fee, so the amounts they receive don't even match those in the 835 and there is no line item detail in their bank account to reconcile to.

Accordingly, with existing conventional payment methods, some level of manual processing is generally required; unlike the EDI transfer systems with which they are generally employed. Moreover, conventional payment systems are often operated through wholly distinct systems that must be separately actuated and managed from the EDI systems. Consequently, in the context of the overall claim payment process, many of the benefits and efficiencies introduced by the use of standardized electronic remittances are undermined or otherwise mitigated by such funds transfer methods.

Therefore, a problem which still exists is that conventional funds payment systems in scenarios where the payer has no financial relationship or financial information on file for the payee (i.e., non Medicare/Medicaid payers and non captive provider networks) not only typically lack full integration with EDI systems, but also usually re-introduce manual processing steps which EDI systems have eliminated. Thus, there remains a need for a system and method for concurrent electronic remittance and funds transfer which integrates standardized electronic remittance transmittals with funds transfers such that payment data in the standardized electronic remittance and the associated payment were simultaneously sent through a single action. It would be helpful if such a system and method for concurrent electronic remittance and funds transfer enabled both the direct electronic delivery of the payment data in the standardized electronic remittance into a payee's management software and the direct electronic transfer of funds into the payee's bank account. It would be additionally desirable for such a system and method for concurrent electronic remittance and funds transfer to be operative through a payee's existing EDI system/connection and existing bank account, without requiring the use of a separate payment card account or the distribution of bank account and routing numbers and/or transit information.

The Applicant's invention described herein provides for a system and method adapted to enable the availing of an standardized electronic remittance file containing payment data, such as an 835, simultaneously with the electronic transfer of funds for amounts specified in the remittance, particularly in cases where ACH and EFT are not available. The primary operational steps of Applicant's system and method for concurrent electronic remittance and funds transfer are transmitting a payment notice to a payee that enables the acceptance of a payment of a set amount, upon acceptance of the payment notice, associating an standardized electronic remittance file with a payment card directly tied to the payee's bank account, and initiating an original credit transaction on the payment card while availing the standardized electronic remittance data file to the payee. When in operation, the system and method for concurrent electronic remittance and funds transfer allows for fund transfers in an EDI environment to be automatically tied to a relevant standardized electronic remittance, thereby retaining many of the benefits and efficiencies attained through the use of such standardized electronic remittances. As a result, many of the limitations imposed by prior art systems and methods are removed.

### SUMMARY OF THE INVENTION

A system and method for concurrent electronic remittance and funds transfer that allows for the simultaneous electronic transfer of funds to a service provider for payment of a liability and transmission of a standardized electronic remittance transmittal which includes details concerning the payment. The system and method for concurrent electronic remittance and funds transfer, when implemented in medical billing environments, is operative to transmit an electronic notice of payment for a specified amount to a service provider payee upon receipt of an electronic claim payment file from a health insurer payer. Once electronic payment is accepted by the payee in response to the notice of payment, an Original Credit Transaction that immediately credits funds in the specified amount into an existing bank account of the payee. At the same time, an 835 Electronic Remittance Advice which includes details about the Original Credit Transaction is electronically transmitted or otherwise availed to the payee, enabling the payment transaction to be automatically documented in the payee's practice management system that receives the 835.

Moreover, unlike stored valued cards, a merchant interchange fee is not automatically deducted from the amount sent via the Original Credit Transaction. The system and method for concurrent electronic remittance and funds transfer enables the exact amount of the payment due to be deposited into the payee account, with a service fee to be charged separately. Thus, the payee can reconcile on the amount deposited (and the fee charged).

The use of the Original Credit Transaction additionally enables the provision of line item detail to the bank transaction history that both identifies the source of the payment and the matching Transaction ID, so the payee can easily identify and reconcile the payment with the 835.

In practice, the system and method for concurrent electronic remittance and funds transfer provides a value proposition for medical claims payers that is achieved through improved provider payment efficiencies while dramatically reducing expenses. In addition, service providers benefit because the system and method is able to both (1) convert the paper check claim payment files originated by third party payers into electronic, real-time, funds transfers that are directly deposited into a medical provider's existing bank account and (2) simultaneously provide each medical provider with an 835 Claim Remittance file that can be downloaded immediately or delivered directly into the provider's existing practice management system via their existing EDI connection for a single, low, fixed cost.

The advantages provided by the system and method for concurrent electronic remittance and funds transfer include: (1) electronic delivery that combines both an immediate payment & immediate delivery of an 835 remittance to providers; (2) an initial emailed payment notice designed for maximum reach to all providers and which includes provider self enrollment instructions to become a participating network provider, thereby increasing adoption; and (3) reductions in a payer' s administrative expenses from the first day of service, including potentially over a 50% reduction in printed check and postage expenses while eliminating most bank check fees as well as improved internal payment efficiencies lowers the volume of provider office inquiries.

Indeed, by just looking to the printed check and postage expenses, it is evident that a substantial savings can be attained with merely a 70% provider adoption rate:

| | |
|---|---|
| Paper Check Payments Produced Monthly | 100,000 |
| Paper Check Expense | $0.55 |
| Estimated Monthly Payment Expenses | $55,000 |
| % of Providers ePayment Adoption | 70% |
| Monthly Reduction In Check Expenses | $38,500 |
| Payer's Projected Annual Savings | $462,000 |

It is an object of this invention to provide a system and method for concurrent electronic remittance and funds transfer which integrates standardized electronic remittance transmittals with funds transfers such that payment data in the standardized electronic remittance and the associated payment were simultaneously sent through a single action.

It is another object of this invention to provide a system and method for concurrent electronic remittance and funds transfer that enables both the direct electronic delivery of the payment data in the standardized electronic remittance into a payee's management software and the direct electronic transfer of funds into the payee's bank account.

It is yet another object of this invention to provide a system and method for concurrent electronic remittance and funds transfer operative through a payee's existing EDI system/connection and existing bank account, without requiring the use of a separate payment card account.

These and other objects will be apparent to one of skill in the art.

### BRIEF DESCRIPTION OF THE DRAWINGS

FIG. 1 is a block diagram showing the entity interactions of a system and method for concurrent electronic remittance and funds transfer in accordance with the present invention.

FIG. 2 is a flow chart illustrating the substantive operational steps of a system and method for concurrent electronic remittance and funds transfer in accordance with the present invention.

FIG. 3 is a diagrammatic view of a payee enrollment process of a system and method for concurrent electronic remittance and funds transfer in accordance with the present invention.

FIG. 4 is a diagrammatic view of a payee payment process of a system and method for concurrent electronic remittance and funds transfer in accordance with the present invention.

### DETAILED DESCRIPTION OF THE INVENTION

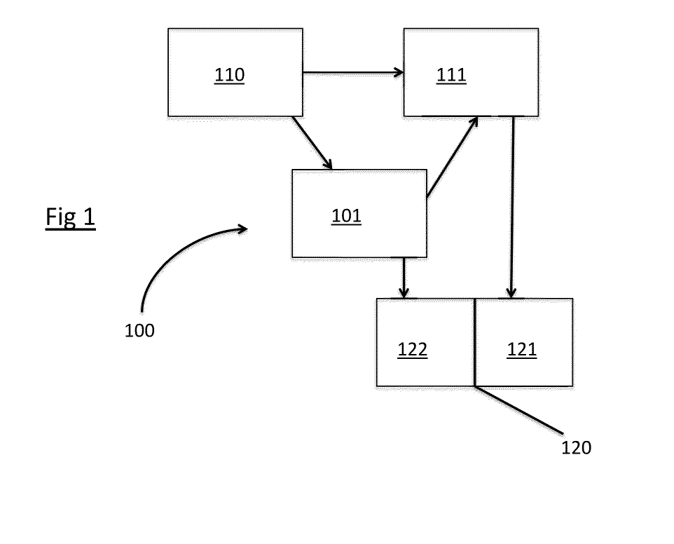

Referring now to the drawings and in particular FIG. 1, a system and method for concurrent electronic remittance and funds transfer 100 enables a system administrator 101 to coordinate the provision of a standardized electronic remittance transmittals from a payer 110 to a payee 120 with the electronic transfer of funds from the payer's funding source 111 to the payee 120 that is documented by the electronic remittance transmittal. In the preferred embodiment, system and method for concurrent electronic remittance and funds transfer 100 is implemented in medical billing environments, with the payer 110 defining a health insurance company (or “health payer”), the payee 120 defining a medical services provider, and the electronic remittance transmittal defining an Electronic Remittance Advice, such as an 835 (or an Explanation of Benefits). It is contemplated that in alternate embodiments, the system and method for concurrent electronic remittance and funds transfer 100 may be along with EDI exchanges in other industries, and in conjunction with other documents (such as purchase orders, invoices, and shipping notices).

In the preferred embodiment, the system and method for concurrent electronic remittance and funds transfer 100 enables the administrator 101 to receive from the payer 110 an electronic paper check claim payment file (or an API) detailing a claim payment to a specific payee 120 and then convert the paper check claim payment file into an electronic fund transfer so that the payment can be directly deposited into an existing bank account 121 of the payee 120. As with existing paper check and electronic transfer payments, it is contemplated that when the paper check claim payment file is sent, the payer 110 will fund the payment by transferring the amount to be paid into a payer merchant account 111 at a sponsor bank, thereby availing the funds underlying the electronic paper check claim payment file for payment.

To allow for direct deposit, the identifying information for a payment card directly tied to the desired bank account 121 (i.e., the issuing bank), such as a debit card or an ATM card must be provided. With the payment card information, the administrator 101 initiates an Original Credit Transaction on the payment card, thereby causing the funds to be credited to the bank account 121 tied to the payment card and debited from the merchant account 111.

At the same time, the administrator 101 initiates the creation of an 835 from the paper check claim payment file which includes all of the claim payment information in the HIPAA mandated ACSX12 005010X221A1 format. This 835 is then availed to the payee 120, typically by causing it to be directly transmitted to the existing EDI management system 122 of the payee 120, commonly embodied as a practice management application on the payee's computer system.

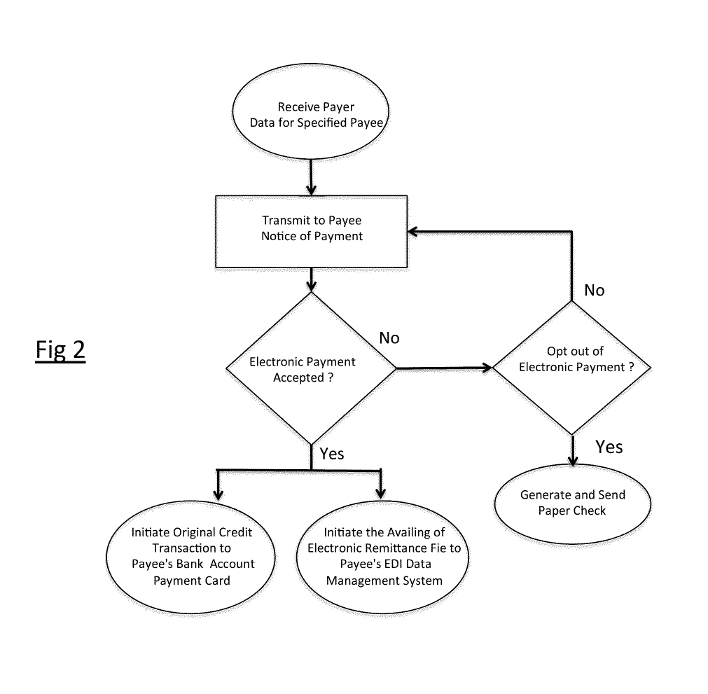

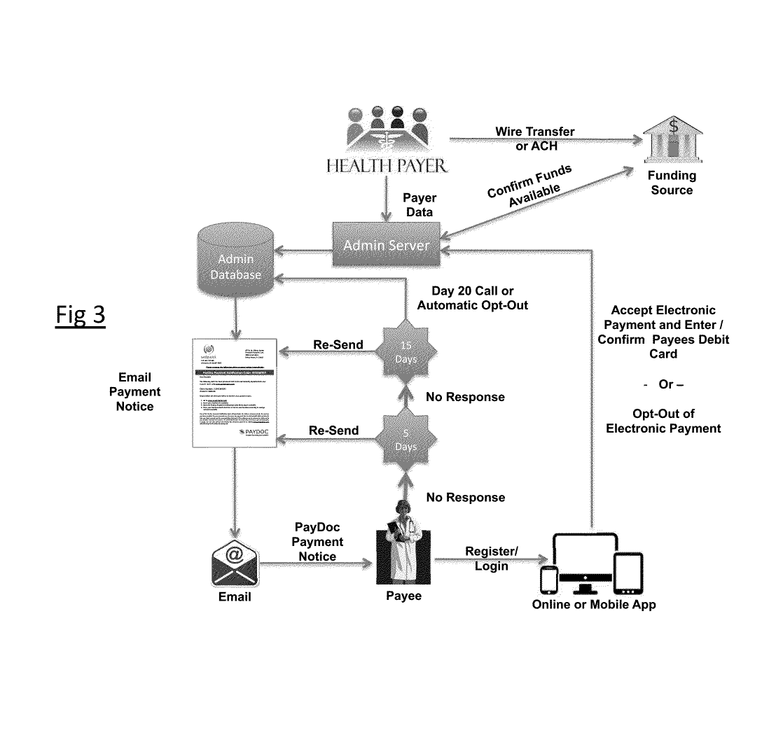

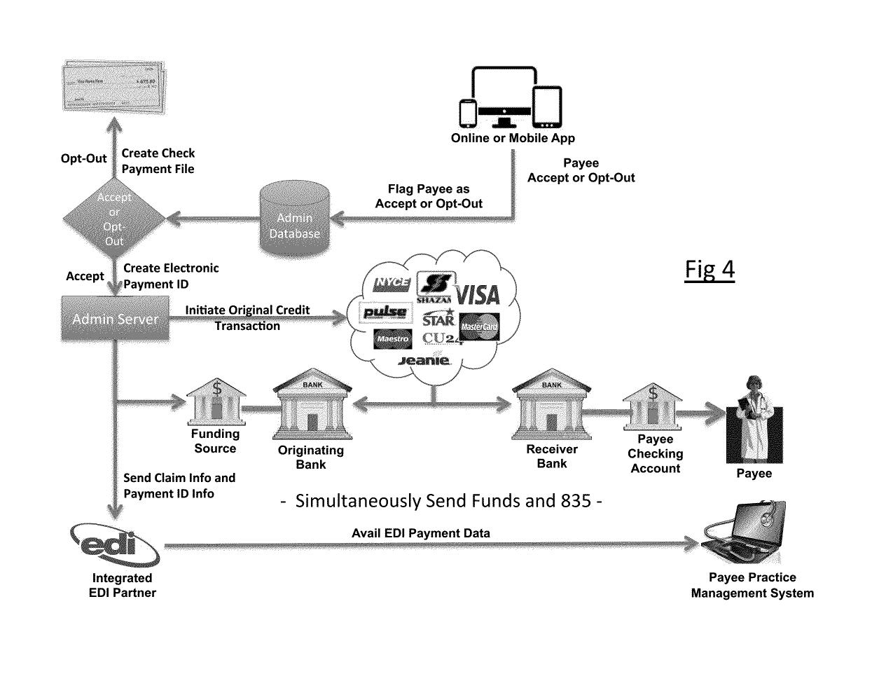

Referring now to FIGS. 2, 3, and 4, the process by which a standardized electronic remittance is concurrently availed with an electronic transfer the payment funds to a payee is facilitated through an administrator system. In the preferred embodiment, the administrator system is embodied as one or more computer systems connected to a computer network, such as the Internet such that it is able to communicate data electronically with the computer systems of a payer, a payee, and their respective financial institutions.

The electronic remittance and funds transfer process beings with the administrator system receiving a payer data entry for a specified claim transaction. The payer data entry is typically provided by the payer who is paying the claim, who in addition to transmitting the payer data entry will also transfer to a funding source the amount to be paid under the payer data entry. It is contemplated that such a payer data entry may be embodied as a conventional paper check claim payment file and would necessarily include payment entry information which would enable the creation of a paper check for mailing (or the initiation of some other form of electronic fund transfer) and a 835 for allowing claim payments to be autoposted into the payee's practice management system.

Upon receipt of the payer data entry, the administrator system confirms the availability of the payment amount in the funding source and logs the payment entry information in a database for storage and facilitating the population of payee, payer, and claim information into subsequently generated documents and files, such as payment notices, 835s, and Original Credit Transactions. Once the payer data entry is logged, the administrator system generates and emails a payment notice to the payee identified in the payer data entry. The payment notice provides a notification of the pending payment as well as information related to the amount of the payment and instructions on how to claim the payment. In the preferred embodiment, the payment notice allows the payee to either agree to accept the payment electronically as a direct deposit or to opt out of receiving the payment as a direct deposit. Accordingly, the payment notice provides instructions that direct the payee to a web interface or an software app through which they can access the administrator system portal to either (1) register (if a new user) with or log in (if a previous user) to the administrator system's electronic payment interface and accept the electronic payment by entering or confirming the identifying information for the payment card linked to their desired bank account or (2) opt out of electronic payment and elect to receive a paper check. It is contemplated that by registering with the administrator system's electronic payment interface, the payee may also be required to create login information and provide further contact, banking, tax, claim and medical practice information in addition to the payment card information. Such additional information may subsequently be used by the administrator system for authentication, verification, security, and reporting purposes.

In the event a payee does not respond to the payment notice through the web interface or software app, it is contemplated that the administrator system will re-send the payment notice to the payee. If no response is received after the payment notice has been resent multiple times, the administrator system may be instructed to generate a prompt requiring the payee to receive a telephone call and/or automatically opt out the payee, treating it as a default election to receive a paper check.

In the preferred embodiment, if the initial payment notice is not responded to within five days, a first subsequent payment notice is sent and, if no response is received to within fifteen days of the original payment notice, a second subsequent payment notice is sent. If no response is received within twenty days of the original payment notice, the payee is designated as opting out of electronic payment.

The accepting of electronic payment or opt out status of the payee to whom a payment notice has been sent are logged by the administrator system in the database based on the response provided by the payee (or the lack thereof). For a payee designated as having opted out of receiving an electronic payment, a create check file is generated which allows for the processing and mailing of a paper check to the payee as well as the transmission of an associated 835 in a substantially similar manner to which paper checks have been traditionally distributed with 835s.

For a registered payee who has provided their acceptance of an electronic payment through the administrator system portal (or API), the administrator system creates an electronic payment identification entry, which it uses to provide payment transaction details to the appropriate payment gateway (and, in some cases an electronic payment system) so as to initiate an Original Credit Transaction for the amount to be paid (as specified by the payer data entry). By this action, funds in that amount to be paid are pushed directly into the payee's bank account. At the same time, the administrator system initiates the creation of an 835 with the claim and other information provided in the payer data entry, as well as the electronic payment identification entry information. The created 835 is then availed to the payee, advantageously including data from the payment electronic payment identification entry information so that the electronic payment transaction can be automatically reconciled in the payee's practice management system.

In the preferred embodiment, the administrator system includes an integrated EDI reporting platform through which the 835 is availed to the payee. It is understood that in an alternate embodiment, the administrator system may employ a third party EDI partner in the alternative or in addition to the integrated EDI reporting platform. In any event, the 835 is availed to the payee's practice management system either through a direct transmission of data through the payee's existing EDI system/connection or by providing the same for download directly or indirectly into the payee's EDI data management system.

The instant invention has been shown and described herein in what is considered to be the most practical and preferred embodiment. It is recognized, however, that departures may be made therefrom within the scope of the invention and that obvious modifications will occur to a person skilled in the art.

What is claimed is:

1. A method for transmission of a standardized electronic remittance for a medical claim and electronic funds transfer for payment of the medical claim, comprising the steps of:
processing by an administrator system a claim payment file for a specified medical claim to be paid to a payee, wherein the step of processing includes extracting from the claim payment file information sufficient to enable the creation of an electronic payment explanation document and the identification of a payment amount;
receiving by said administrator system identifying information for a target payment card directly tied to an existing bank account associated with the payee;
initiating by said administrator system an Original Credit Transaction on the target payment card for the identified payment amount, thereby causing funds totaling the identified payment amount to be immediately credited to the existing bank account; and
availing to the payee a standardized electronic remittance of an electronic payment explanation document containing data derived from the claim payment file and the Original Credit Transaction, wherein the standardized electronic remittance of the electronic payment explanation document is availed automatically upon the crediting of the payment amount.

2. The method for transmission of a standardized electronic remittance for a medical claim and electronic funds transfer for payment of the medical claim of claim 1, wherein the step of processing additionally includes extracting from the claim payment file information sufficient to transmit an electronic communication to the payee.

3. The method for transmission of a standardized electronic remittance for a medical claim and electronic funds transfer for payment of the medical claim of claim 2, additionally comprising the step of transmitting by said administrator system a payment notice to the payee which enables the payee to specify the target payment card.

4. The method for transmission of a standardized electronic remittance for a medical claim and electronic funds transfer for payment of the medical claim of claim 1, wherein the standardized electronic remittance of the electronic payment explanation document is availed to the payee concurrently with the crediting of the payment amount.

5. The method for transmission of a standardized electronic remittance for a medical claim and electronic funds transfer for payment of the medical claim of claim 1, wherein the standardized electronic remittance of the electronic payment explanation document is uploaded directly into the payee's existing computer system.

6. The method for transmission of a standardized electronic remittance for a medical claim and electronic funds transfer for payment of the medical claim of claim 1, wherein the electronic payment explanation document is availed to the payee by download over a computer network.

7. The method for transmission of a standardized electronic remittance for a medical claim and electronic funds transfer for payment of the medical claim of claim 1, wherein the step of availing to the payee a standardized electronic remittance of an electronic payment explanation document is performed by an EDI reporting platform integral with the administrator system.

8. The method for transmission of a standardized electronic remittance for a medical claim and electronic funds transfer for payment of the medical claim of claim 1, wherein the target payment card defines a debit card.

9. A method for transmission of a standardized electronic remittance for a medical claim and electronic funds transfer for payment of the medical claim, comprising the steps of:
processing by an administrator system a claim payment file for a specified medical claim to be paid to a payee, wherein the step of processing includes extracting from the claim payment file information sufficient to enable the creation of an electronic payment explanation document and the identification of a payment amount;
receiving by said administrator system either (1) identifying information for a target payment card directly tied to an existing bank account associated with the payee or (2) a refusal of electronic funds transfer;
upon receiving identifying information for the target payment card, initiating by said administrator system an Original Credit Transaction on the target payment card for the identified payment amount, thereby causing funds totaling the identified payment amount to be immediately credited to the existing bank account;
upon receiving the refusal of electronic funds transfer, initiating by said administrator system a create check file; and
availing to the payee a standardized electronic remittance of an electronic payment explanation document containing data derived from the claim payment file and the Original Credit Transaction, wherein the standardized electronic remittance of the electronic payment explanation document is availed automatically upon the crediting of the payment amount or the creation of a check file.

10. The method for transmission of a standardized electronic remittance for a medical claim and electronic funds transfer for payment of the medical claim of claim 9, wherein the step of processing additionally includes extracting from the claim payment file information sufficient to transmit an electronic communication to the payee.

11. The method for transmission of a standardized electronic remittance for a medical claim and electronic funds transfer for payment of the medical claim of claim 10, additionally comprising the step of transmitting by said administrator system a payment notice to the payee which enables the payee to specify the target payment card.

12. The method for transmission of a standardized electronic remittance for a medical claim and electronic funds transfer for payment of the medical claim of claim 9, wherein the standardized electronic remittance of the electronic payment explanation document is availed to the payee concurrently with the crediting of the payment amount or the creation of a check file.

13. The method for transmission of a standardized electronic remittance for a medical claim and electronic funds transfer for payment of the medical claim of claim 9, wherein the standardized electronic remittance of the electronic payment explanation document is uploaded directly into the payee's existing computer system.

14. The method for transmission of a standardized electronic remittance for a medical claim and electronic funds transfer for payment of the medical claim of claim 9, wherein the electronic payment explanation document is availed to the payee by download over a computer network.

15. The method for transmission of a standardized electronic remittance for a medical claim and electronic funds transfer for payment of the medical claim of claim 9, wherein the step of availing to the payee a standardized electronic remittance of an electronic payment explanation document is performed by an EDI reporting platform integral with the administrator system.

16. The method for transmission of a standardized electronic remittance for a medical claim and electronic funds transfer for payment of the medical claim of claim 9, wherein the standardized electronic remittance of the electronic payment explanation document defines an 835.

17. A method for transmission of a standardized electronic remittance for a medical claim and electronic funds transfer for payment of the medical claim, comprising the steps of:
processing by an administrator system a claim payment file for a specified medical claim to be paid to a payee, wherein the step of processing includes extracting from the claim payment file information sufficient to enable the creation of an 835 Electronic Remittance Advice, the transmission an electronic communication to the payee, and the identification of a payment amount;
transmitting by said administrator system a payment notice to the payee which enables the payee to specify the target payment card;
in response to the payment notice, receiving by said administrator system either (1) an acceptance of electronic payment which includes at least one of the provision of identifying information for a target payment card directly tied to an existing bank account associated with the payee and the confirmation of the identifying information for a target payment card or (2) a refusal of electronic funds transfer;
upon receiving the acceptance of electronic payment, initiating by said administrator system an Original Credit Transaction on the target payment card for the identified payment amount, thereby causing funds totaling the identified payment amount to be immediately credited to the existing bank account;
upon receiving the refusal of electronic funds transfer, initiating by said administrator system a create check file; and
availing to the payee an 835 Electronic Remittance Advice containing data derived from the claim payment file and the Original Credit Transaction, wherein the 835 Electronic Remittance Advice is availed automatically upon the crediting of the payment amount or the creation of a check file.

18. The method for transmission of a standardized electronic remittance for a medical claim and electronic funds transfer for payment of the medical claim of claim 17, wherein the 835 Electronic Remittance Advice is availed to the payee concurrently with the crediting of the payment amount or the creation of a check file.

19. The method for transmission of a standardized electronic remittance for a medical claim and electronic funds transfer for payment of the medical claim of claim 17, wherein the 835 Electronic Remittance Advice is uploaded directly into the payee's existing computer system.

20. The method for transmission of a standardized electronic remittance for a medical claim and electronic funds transfer for payment of the medical claim of claim 17, wherein the step of availing to the payee an 835 Electronic Remittance Advice is performed by an EDI reporting platform integral with the administrator system.
